(19) United States
(12) Patent Application Publication
(10) Pub. No.: US 2020/0224481 A1
(43) Pub. Date: Jul. 16, 2020

(54) MOTOR VEHICLE DOOR, IN PARTICULAR MOTOR VEHICLE SLIDING DOOR

(71) Applicant: Kiekert AG, Heiligenhaus (DE)

(72) Inventor: Inga Heinzen, Krefeld (DE)

(21) Appl. No.: 16/647,073

(22) PCT Filed: Sep. 7, 2018
(86) PCT No.: PCT/DE2018/100762

§ 371 Date: Mar. 13, 2020

(30) Foreign Application Priority Data
Sep. 13, 2017 (DE) 10 2017 121 150.0

(51) Int. Cl. E05F 15/657; B60J 5/06; E05F 15/659

(52) U.S. Cl. CPC E05F 15/657; E05Y 2900/531; E05F 15/659; B60J 5/06

(57) ABSTRACT

A motor vehicle door, in particular a motor vehicle sliding door, having a motorized drive and a downstream coupling device for acting on a door leaf, and having a control unit for the drive and the coupling device. The coupling device is generally disengaged and is only engaged for the motorized driving of the door leaf.

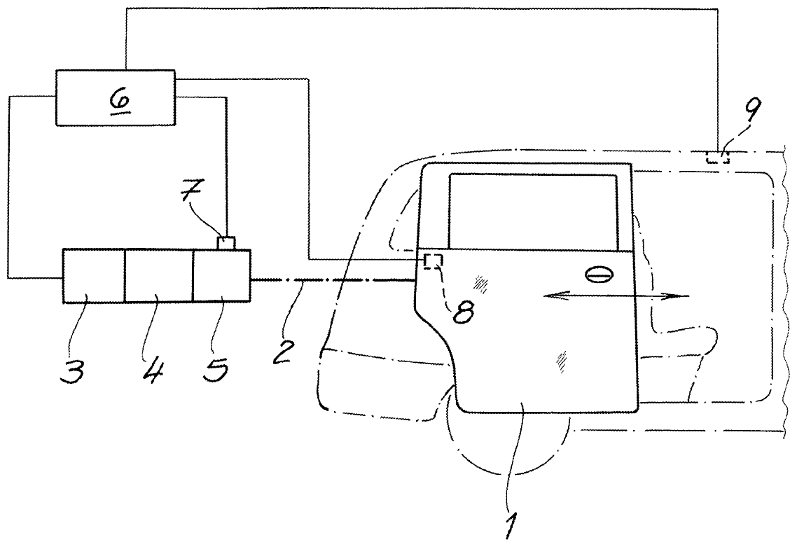

The invention relates to a motor vehicle door, in particular a motor vehicle sliding door, having a motorized drive and a downstream coupling device for acting on a door leaf, and having a control unit for the drive and the coupling device.

Motor vehicle doors and in particular motor vehicle sliding doors can in principle be moved manually, but in practice they often have a drive and a downstream coupling device. By means of the control unit, the coupling device can be switched into its “engaged” and “disengaged” positions. If the coupling device is “engaged” and the drive is acted on by means of the control unit, the door leaf connected to the coupling device can be moved back and forth. In principle, this can be done remotely or by means of switches located inside the motor vehicle, and has generally proven itself. The self-locking forces of the drive prevent the door leaf from moving on its own, when the coupling device is engaged, as the result of an incline, at least as long as the incline does not exceed a predetermined value. A mechanical door operation is made more difficult by the self-locking forces when the coupling device is engaged; such a mechanical door operation can be provided as an emergency opening when the coupling device is engaged. If the coupling device is in its “disengaged” position, the door leaf behaves like a purely mechanical door leaf, such that a manual opening is easily possible.

In fact, in the generic state of the art according to DE 198 13 513 A1, the procedure is, inter alia, that the control unit engages and/or disengages the coupling device in order to stop the door leaf. This allows the door leaf to be moved mechanically. In addition, a movement of the door leaf by its own weight can be detected in this way by means of an output signal for detecting the movement. This allows conclusions to be drawn about the inclination of the motor vehicle. This means that the vehicle's inclination is ultimately determined via a movement of the door leaf.

In the known teaching according to DE 198 13 513 A1, the focus is determining an inclination of the vehicle body with respect to its longitudinal direction during a movement of the door leaf without a sensor or other suitable devices. In this connection, the coupling device works electromagnetically and is always in its “engaged” position.

The coupling device is “disengaged” only for the previously described inclination detection of the body.

In the further prior art according to DE 10 2008 008 178 A1, a method and a device for supporting an operation of a body component of a vehicle that can be moved by hand are described. The body component can be closed automatically, inter alia, as a function of a detected force and/or detected contact of an operating element by means of a controllable electric drive. In this way, the force required to open or close the body component should be reduced overall.

The state of the art has generally proven itself with regard to the use of a control unit and the drive which it acts on, and the downstream coupling device for acting on the door leaf connected to it. However, problems do arise in practice and lead to resulting operating situations that have so far not been overcome satisfactorily. As such, the previous approach of working with the coupling device generally engaged corresponds to the fact that in the event of a failure of the drive and/or an electric motor typically used at this position, the door leaf can only be moved mechanically with increased manually-applied forces. This is not very practical.

At this point, there are approaches for moving the coupling device into its “disengaged” functional position via an emergency operation. However, this requires additional elements for the emergency operation, which on the one hand increase the weight of the door leaf equipped with them, and on the other hand also lead to a not inconsiderable increase in the cost of the drive as a whole.

In addition, problems can arise in the event that the door leaf is, for example, in an intermediate position between its open position and closed position and at the same time the motor vehicle is on an incline. As soon as the coupling device is “disengaged” in this case, this can lead to the door leaf automatically executing a movement, as is used in the prior art according to DE 198 13 513 A1 in order to infer the inclination of the motor vehicle body.

However, such an approach is relatively unreliable, for example because guides for the door leaf of the motor vehicle sliding door can sometimes be difficult to move and, in particular, aging effects of the guides can hardly be reproduced. This can also result in uncontrolled door movements. The invention as a whole aims to remedy this.

The invention is based on the technical problem of developing such a motor vehicle door and in particular a motor vehicle sliding door in such a manner that manual emergency operation is implemented in a simple manner with and little force, and any inclination of the motor vehicle body is easily taken into account. In addition, this should be done overall with reduced design and financial costs.

To solve this technical problem, a generic motor vehicle door and in particular a motor vehicle sliding door is characterized in the context of the invention in that the coupling device is generally disengaged and is only engaged for the motor to drive the door leaf. In this context, the fact that the coupling device is generally disengaged and is only engaged for the motor to drive the door leaf means that the coupling device is always disengaged when the door is closed, is engaged at the beginning of a motorized drive movement, and remains engaged during the motorized drive movement. After the motorized drive movement has ended, the coupling device can remain engaged or be disengaged if the door leaf is in a position other than the closed position. If the door leaf is moved into the closed position by means of the motorized drive, the coupling device is once more disengaged. This means that by generally assuming the “disengaged” position of the coupling device, the door leaf can be moved back and forth mechanically and manually as if the additional drive were not present at all. This is always the case as long as there is no motorized operation of the door leaf and/or the same is not desired by an operator. All of this works in general without the need for complex emergency operation devices. Only when a motorized adjustment and/or action on the door leaf is desired does the control unit ensure, on the one hand, that the coupling device assumes its “engaged” position and, on the other hand, that the drive is acted upon. The drive consequently works on the engaged coupling device, which in turn then moves the connected door leaf by motor.

In one embodiment, the design is advantageously such that the coupling device usually maintains its engaged position even when the door leaf assumes a static intermediate position between its open and closed positions upon operation by a motor. In this context, the fact that the coupling device usually maintains its engaged position even when the door leaf assumes a static intermediate position between its open and closed positions upon operation by a motor means that the coupling device maintains the engaged position for static intermediate positions in a predefined range along a total length of a displacement travel of the door leaf, wherein the predefined range makes up at least more than half, advantageously at least more than two thirds, of the total length of the displacement distance. The control unit implements this. In this case, the door leaf is at rest. Due to the self-locking of the drive, it is ensured in this intermediate position when the coupling device is engaged that the motor vehicle door does not accidentally roll out of the intermediate position.

If the motor vehicle is on a flat surface and the door leaf is at rest after the motor movement, so that it is no longer driven by a motor, the coupling device is again switched into its “disengaged” functional position. According to the invention, the open and closed position of the door leaf correspond to this. If the vehicle is parked on a slope, the coupling device regularly maintains its “engaged” functional position, regardless of which position the door leaf is currently in. Here, the invention proceeds from the knowledge that an operator can act on the drive with the downstream coupling device via the control unit in such a way that the door leaf can be stopped in any position between the open position and the closed position. As a result, a separate door arrester for the end position as provided in the prior art is unnecessary, which reduces the design complexity.

The previously-mentioned static intermediate position between the open position and the closed position of the door leaf corresponds to this. Such a static intermediate position can be determined easily and advantageously by sensors. This is because the door leaf is generally equipped with a position sensor connected to the control unit. By means of this position sensor, the position of the door leaf can be determined in relation to the body, and at least the three basic positions “open position,” “closed position” and “any intermediate position between the open position and closed position” can be correctly detected and distinguished from each other. The control unit then acts on the coupling device in accordance with corresponding signals from the position sensor.

In one embodiment of the motor vehicle door according to the invention, the control unit is provided to also disengage the coupling device when the static intermediate position lies within a predefined width. In this context, “provided” is to be understood to mean that the control unit is programmed accordingly. The predefined width can be specified in any desired manner and, for example, selected so that a person can exit the vehicle at any time. For example, the predefined width can be set to 50 cm. This configuration can ensure that the motor vehicle door can be manually moved in a range which is large enough to allow exiting, and an emergency exit can thus be secured.

If the door leaf is in the open position or the closed position in a motor vehicle which is on a flat surface, the drive is switched off after an action has been made beforehand and, at the same time, the coupling device is “disengaged.” If, on the other hand, the door leaf assumes the desired static intermediate position between the open position and the closed position in accordance with an operator's command, or if the motor vehicle is on a slope, the control unit generally leaves the coupling device in its “engaged” functional position.

As a result, the mechanical door arrester mentioned above can be dispensed with and the sliding door is correctly held in the intermediate position in question. This holding position and/or intermediate position of the door leaf in the “engaged” position of the coupling device is essentially explained by the self-locking of the drive or an optionally provided gearing. This means that the door leaf can also be moved back and forth manually and mechanically in the intermediate position, should this be necessary in the course of an emergency operation.

In a further advantageous embodiment with particular importance, it is provided that the control unit additionally acts on the coupling device according to signals from an inclination sensor. In this case, the control unit not only evaluates any operating commands from an operator and signals from the previously-mentioned position sensor on or in the door leaf, but also signals from the inclination sensor. Such an inclination sensor is usually present anyway in modern motor vehicles and can be queried for its signals via a bus system which is present, for example, in the motor vehicle.

A parking brake, for example, is typically activated by means of the inclination sensor in order to make it easier for a vehicle driver to start driving on a slope. The invention at this point additionally uses the signal from this inclination sensor, which is usually present or required anyway, for driving the door leaf. This is because, according to a further advantageous embodiment, the design is such that the control unit, according to signals from the inclination sensor, only holds the coupling device in the “engaged” position if the door leaf is at rest in the static intermediate position and at the same time the inclination sensor registers a vehicle inclination.

In addition, the inclination sensor is only used and evaluated by the control unit to act on the coupling device when the door leaf is in the static intermediate position between its open position and closed position. This means that as soon as the door leaf has reached the open or closed position in question by the motorized drive, the drive is mandatorily switched off and the coupling device is switched into its “disengaged” position. This is because, in the closed position, the door leaf is secured by means of a motor vehicle door lock and held in the closed position. If, on the other hand, the door leaf assumes the open position, the “disengaged” functional position of the coupling device is even desirable, since the door leaf can then be moved back and forth manually by an operator, for example, similarly to a door leaf that works purely mechanically.

The additional query of the signals of the inclination sensor by means of the control unit now has the advantage that the coupling device can also assume its “disengaged” functional position when the door leaf assumes a static intermediate position between its open and closed positions. In any case, this applies as long as the inclination sensor registers no or practically no vehicle inclination. As a result, the door leaf can be moved back and forth manually and mechanically without any problems after the intermediate position in question has been reached, because in this case the coupling device assumes its “disengaged” functional position. During the movement of the door leaf starting from the open position or the closed position to the intermediate position, the coupling device is of course in its “engaged” position in order to be able to move the door leaf by motor.

However, as soon as the static intermediate position between the open and closed position is reached, the coupling device is switched into its “disengaged” functional position by the control unit, provided that the inclination sensor does not report any significant vehicle inclination to the control unit. Only if the inclination sensor detects a significant vehicle inclination in this scenario does the control unit ensure that the coupling device maintains its “engaged” functional position, and specifically only when the door leaf has reached the static intermediate position between its open position and closed position. In this way, it is ensured that the door leaf comes to a halt, particularly on a slope, and does not move by itself. In this way, any injuries or undesired functional states can be reliably prevented without a separate mechanical door lock.

In a preferred embodiment, the control unit is provided to keep the coupling device disengaged in all intermediate positions when on a flat surface. In this context, a “flat surface” is to be understood to mean that an inclination of 0±0.5 degrees was determined via the inclination sensor. In particular, assuming a so-called workshop mode, in which a motor vehicle is verified, can be facilitated in this way, since a flat surface is found in the workshop and, in this embodiment, a separate method step for disengaging the motor vehicle door is unnecessary.

If there is a power failure in the intermediate position in question, the coupling device remains “engaged” in its functional position and the door leaf is held in the intermediate position by a self-locking of the drive. This is not critical because in this case the door leaf is already open and an operator can manually and mechanically move the door leaf into the open position or the closed position in the course of an emergency operation. To facilitate operation at this point, it is conceivable that the coupling device is equipped with an emergency operation element. By means of the emergency operation element, the coupling device can, in the case of the example, be moved from its “engaged” functional position to the “disengaged” position, so that the door leaf can then be moved mechanically and manually with little force and as desired.

It has proven itself for the coupling device to be equipped with an electrically operable coupling drive. Because of this design, the electrically operable coupling drive can respond directly by means of the control unit. In this case, the electrically operable coupling drive ensures that the coupling device assumes its “engaged” or “disengaged” position depending on a corresponding signal from the control unit. For this purpose, the electrically operable coupling drive is connected to the control unit.

In addition, it has generally proven itself in this context if the coupling device works mechanically and the “engaged” and “disengaged” positions correspond to an existing and/or lacking positive connection. In principle, however, the coupling device can also be designed as a magnetic coupling, for example. The invention also relates to a method for operating a corresponding motor vehicle door and in particular a motor vehicle sliding door, as described in claim 10.

As a result, a motor vehicle door and in particular a motor vehicle sliding door, and a method for operating such a motor vehicle door are presented, by means of which virtually all scenarios that occur in practice can be represented with little effort. In fact, at this point, for example, a door lock is just as unnecessary as complex measures for emergency operation of the door leaf. In essence, the invention achieves this in that the coupling device is generally disengaged and is only engaged when the door leaf should be driven by a motor.

The engaged position of the coupling device is additionally and advantageously maintained when the door leaf assumes an intermediate position between its open position and closed position and a vehicle inclination is also registered. As a result, the door leaf can be moved mechanically and manually if necessary, on the one hand, and on the other hand a motorized movement into any position is possible. All of this is possible without the door leaf making an uncontrolled movement even when the vehicle is inclined. The essential advantages can be found therein.

The invention is explained in more detail below with reference to a drawing illustrating only one exemplary embodiment. The single FIGURE shows a motor vehicle door according to the invention, and in particular a motor vehicle sliding door, in a schematic overview.

In the single FIGURE, a motor vehicle door, which is a motor vehicle sliding door in the exemplary embodiment shown, is shown schematically. It has a door leaf 1 which can be moved back and forth linearly, for example, as indicated by an arrow. In another embodiment, a pivoting movement of the door leaf 1 for opening and closing the motor vehicle door is also possible. For this purpose, the door leaf 1 in the exemplary embodiment is connected via a flexible connecting means 2 to a motorized drive and/or electromotive drive 3, 4 having a downstream coupling device 5. The drive 3, 4 with the downstream coupling device 5 can, for example, be arranged in a stationary manner in a motor vehicle body, relative to which the door leaf 1 is moved back and forth. In principle, it is also possible to mount the drive 3, 4, including the coupling device 5, inside the door leaf 1. A maximum opening width of the motor vehicle door with maximum displacement of the door leaf 1 is selected so that a Europool pallet with its dimensions of 1200 mm×800 mm can be loaded into the motor vehicle without the Europool palette being tilted.

The basic structure then also includes a control unit 6 which acts on and controls, on the one hand, a motor and/or electric motor 3 as a component of the drive 3, 4 and, on the other hand, an electrically operable coupling drive 7. The control unit 6 may also be arranged inside the door leaf 1 or inside the motor vehicle body, which is not expressly shown.

In the single FIGURE, two sensors 8, 9 are shown. The sensor 8 is a position sensor 8 which is arranged on or in the drive 3, 4 and detects the position of the door leaf 1 with respect to the motor vehicle door body. The position sensor 8 can, for example, be a Hall sensor.

Alternatively, the position sensor 8 can be another sensor which is suitable for directly or indirectly detecting a position of the door leaf 1 with respect to the motor vehicle door body, for example a speed sensor, an optical sensor or a step counter. By means of the position sensor 8, at least one open position, one closed position, and also an intermediate position between the open position and the closed position of the door leaf 1 relative to an opening in the motor vehicle body can be determined.

The sensor 9 is designed according to the embodiment as an inclination sensor 9. Such an inclination sensor 9 is typically present and provided in any motor vehicle anyway, as has already been described in the introduction. The signal from the inclination sensor 9 can be transmitted to the control unit 6, for example, via a bus system within the motor vehicle.

The motor and/or electric motor 3 works on the coupling device 5 via an optional and downstream gearing 4. In the exemplary embodiment, the coupling device 5 is designed to be mechanical and at least assumes the “engaged” and “disengaged” positions. In the “engaged” position, there is a positive connection within the coupling device 5, such that, for example, rotary movements of the electric motor M are transmitted to the flexible connecting means 2 via the gearing 4 and the engaged coupling device 5. The flexible connecting means 2 is advantageously a Bowden cable 2, which may be wound up and unwound on a winding drum, which in turn is acted upon by the drive 3, 4 and the coupling device 5 connected downstream to produce rotation. In alternative configurations, the flexible connecting means 2 can be designed, for example, as a toothed belt or as a fixed Bowden cable 2, which functions similarly to a toothed belt. Since the door leaf 1 is connected to one end of the flexible connecting means and/or the Bowden cable 2, the door leaf 1 can be moved back and forth. For this purpose, the Bowden cable 2 in question is accordingly wound and unwound by the winding drum. Details of such a sliding door drive are well known in the prior art, for which reference is made to the applicant's DE 197 02 698 C2 only by way of example. The coupling device 5 is configured in such a manner that maintaining a set “engaged” or “disengaged” position is realized without current. That is, electrical current is only required for a change between the positions.

The way it works is as follows. As already explained, the control unit 6 functions to act on the drive 3, 4, on the one hand, and to act on the coupling device 5 and/or the associated electrically operable coupling drive 7 on the other hand, by means of which the coupling device 5 can be switched into its basic functional positions “engaged” or “disengaged.” In principle, the coupling device 5 can be designed in the manner and can operate in the manner described in detail in connection with the motor vehicle locking device in accordance with the applicant's DE 10 2009 014 404 A1.

This means that the coupling device 5 works mechanically in the exemplary embodiment and the “engaged” position corresponds to a positive connection of, for example, associated and mutually contacting disks, while the “disengaged” functional position denotes the absence of a positive connection. In addition, the coupling device 5 may be equipped with an emergency operation element (not shown in detail), by means of which the functional positions “engaged” and “disengaged” can be implemented—rather than by the electrically operable coupling drive 7.

The coupling device 5 is generally disengaged in the exemplary embodiment. The coupling device 5 is engaged only for the motor to act on the door leaf 1. For this purpose, an operator can, for example, give a corresponding command to the control unit 6. This can be done using a remote control or a switch in the motor vehicle body. The desired motorized operation of the door leaf 1 now leads to the control unit 6 first switching the coupling device 5 from the generally assumed “disengaged” position to the “engaged” functional position by means of the electrically operable coupling drive 7. This corresponds to a positive connection of the coupling device 5, such that when the electric motor 3 is subsequently acted upon, its rotary movements, by way of example, are ultimately transmitted via the downstream gearing 4 and the following coupling device 5 to the drive drum mentioned above. The rotating drive drum functions so that the flexible connecting means and/orthe Bowden cable 2 is wound or unwound thereon and, as a result, the door leaf 1 connected to the end of the flexible connecting means 2 performs the desired linear movements relative to the motor vehicle body.

The operator can now stop the door leaf 1 in a desired intermediate position between its open position and closed position with respect to the motor vehicle body. This may include a corresponding command which the operator transmits to the control unit 6. In the exemplary embodiment, the assumption of this static intermediate position of the door leaf 1 now corresponds to the fact that the electric motor 3 is no longer acted upon by means of the control unit 6, and the control unit 6 at the same time ensures, via the electrically operable coupling drive 7, that the coupling device 5 leaves its “engaged” position assumed during the movement of the door leaf 1 and switches to the “disengaged” position.

However, this applies only and exclusively in the event that the query of the inclination sensor 9 by means of the control unit 6 has previously shown that there is no inclination of the motor vehicle body. That is, if the motor vehicle is level, the assumption of the intermediate position of the door leaf 1 between its open position and closed position corresponds to the coupling device 5 being disengaged and the electric motor 3 being stopped. As a result of this, the door leaf 1 can, for example, be easily moved back and forth manually by the operator with little force, like a mechanically operating door leaf.

Since the control unit 6 additionally acts on the coupling device 5 according to signals from the inclination sensor 9, a vehicle inclination registered by means of the inclination sensor 9 otherwise leads to the control unit 6 holding the coupling device 5 in the “engaged” position in this case. That is, if the door leaf 1 is at rest in the intermediate position between its open position and closed position and the inclination sensor 9 registers a vehicle inclination at the same time, the control unit 6 ensures that the coupling device 5 maintains its “engaged” functional position.

The consequence of this is that the door leaf 1 is not automatically moved in any direction on a slope after reaching the intermediate position, but rather is held in this intermediate position by self-locking forces. In this case, the coupling device 5 maintains its “engaged” functional position, and associated self-locking forces of the drive 3, 4 ensure that the door leaf 1 is held in the intermediate position, without an additional mechanical locking device being required. The drive 3, 4 is selected in such a manner that the self-locking forces are sufficient for the door leaf 1 to be blocked at an inclination of 30% (±10%).

If there is a failure of the electrical power supply in this case, the door leaf 1 can nevertheless be moved back and forth with ease, specifically by overcoming the self-locking forces of the drive 3, 4 already mentioned. If the motor vehicle is level and in this case the electrical power supply fails, the coupling device 5 even assumes its “disengaged” functional position, such that the door leaf 1 can then be moved back and forth manually and mechanically without difficulty.

In order to also implement the movement of the door leaf 1 manually and mechanically in a simple manner in the event of a failure of the electrical power supply and on a slope, the coupling device 5 and/or the electrically operable coupling drive 7 is equipped with an additional emergency operation element (not shown). In this case, the coupling device 5 can be switched from its assumed “engaged” functional position to the “disengaged” functional position by means of the emergency operating element. The emergency operating element can be designed, for example, as a plastic cable with an eyelet on the coupling drive 7 or as a Bowden cable.

1. A motor vehicle door, in particular a motor vehicle sliding door, having a motorized drive and a downstream coupling device for acting on a door leaf, and having a control unit for the drive and the coupling device, wherein the coupling device is generally disengaged and is only engaged for the motorized driving of the door leaf.

2. The motor vehicle door according to claim 1, wherein the coupling device generally maintains its engaged position even when the door leaf assumes a static intermediate position between its open position and closed position upon motorized operation.

3. The motor vehicle door according to claim 2, wherein the control unit is provided to disengage the coupling device when the static intermediate position lies within a predefined width.

4. The motor vehicle door according to claim 2, wherein the control unit additionally acts on the coupling device according to signals from an inclination sensor.

5. The motor vehicle door according to claim 4, wherein the control unit is provided to keep the coupling device disengaged in all intermediate positions when on a flat surface.

6. The motor vehicle door according to claim 3, wherein the control unit only holds the coupling device in the “engaged” position, according to the signals of the inclination sensor, if the door leaf in the intermediate position is at rest and at the same time the inclination sensor registers a vehicle inclination.

7. The motor vehicle door according to claim 1, characterized in that the coupling device is equipped with an electrically operable coupling drive.

8. The motor vehicle door according to claim 5, wherein the electrically operable coupling drive is connected to the control unit.

9. The motor vehicle door according to claim 1, wherein the coupling device is equipped with an emergency operating element.

10. The motor vehicle door according to claim 1, wherein the coupling device works mechanically and the “engaged” and “disengaged” positions correspond to the presence or absence of a positive connection.

11. The motor vehicle door according to claim 1, wherein a position sensor connected to the control unit for the direct or indirect detection of a door position.

12. A method for operating a motor vehicle door, in particular a motor vehicle sliding door, according to which a control unit acts on a motor drive and on a coupling device downstream thereof with a door leaf connected thereto, characterized in that the control unit keeps the coupling device in its “disengaged” position and only switches it to the “engaged” position to move the door leaf.
